(19) United States
(12) Patent Application Publication
(10) Pub. No.: US 2008/0297413 A1
(43) Pub. Date: Dec. 4, 2008

(54) Slotted Sectored Scheduling with Steerable Directional Antennas in Wireless LANS

(76) Inventors: Ravindranath Kokku, (US); Samrat Ganguly, (US); Vishnu Navda, (US)

Correspondence Address: NEC LABORATORIES AMERICA, INC., 4 INDEPENDENCE WAY, Suite 200, PRINCETON, NJ, 08540, US

(21) Appl. No.: 12/129,027

(22) Filed: May 29, 2008

Related U.S. Application Data
(60) Provisional application No. 60/941,149, filed on May 31, 2007.

(51) Int. Cl. H04Q 7/20; H04B 7/10; H04L 12/56

(52) U.S. Cl. 342/367; 455/111; 455/562.1; 370/339; 370/351

(57) ABSTRACT

A method includes determining for each access point and each associated client that has traffic to exchange with the access point in either directions of a link a pattern of slots of times that causes minimum interference to clients of other access points in a wireless local area network; deriving a conflict graph of pair wise patterns of different access points representing which patterns conflict on a particular client, the conflict graph representing which patterns of the slots cannot be scheduled simultaneously in a slot so as to avoid interference; and generating a schedule for each access points in the slots such that no two conflicting patterns for two different access points are scheduled in the same slot.

This application claims the benefit of U.S. Provisional Application No. 60/941,149, filed May 31, 2007, which is incorporated herein by reference.

### BACKGROUND OF THE INVENTION

The present invention relates generally to wireless communications and, more particularly, to slotted sectored scheduling with steerable directional antennas in wireless local area networks.

3] Directional antenna provides two benefits: a) better link delivery ratio and b) higher spatial reuse. Both of the above benefits result in higher network capacity. However using directional antenna for wireless local area network WLAN creates a set of challenges. Use of a directional antenna at the access point AP can result in the deafness problem where the clients cannot send uplink traffic. With directional antennas in dense WLAN, two APs may not carrier-sense each other resulting in a hidden terminal problem at clients and associated packet collisions. Further, in a wireless LAN network, clients can be positioned arbitrarily. The operation of directional beams must ensure that all clients' downlink and uplink traffic is served and there is no starvation.

Prior work in use of a directional antenna has focused on a multi-hop network backhaul where nodes are fixed, see FIG. 1. The ad hoc networks as shown FIG. 1 focus on the how to use directional antenna to create efficient multi-hop networks of nodes. In this scenario, there is no client level dynamism. Furthermore, all nodes can be modified unlike a WLAN scenario where clients cannot be modified easily. In a WLAN environment, clients can come and go and can be located at any arbitrary position. Other prior work on directional antennas solves part of the challenges through proposing a new media access control MAC. Deploying a new MAC would require modification at clients and would not be able to use legacy 802.11 devices. Other work in using a directional antenna focused on beam-forming to increase the delivery ratio. See the single access point AP WLAN system shown in FIG. 2. This prior work was directed to figuring out the right beam pattern to use for a given client based on physical layer information.

Accordingly, there is a need to increase the capacity of a wireless local area network using a steerable directional antenna.

### SUMMARY OF THE INVENTION

In accordance with the invention, a method includes determining for each access point and each associated client that has traffic to exchange with the access point in either directions of a link a pattern of slots of times that causes minimum interference to clients of other access points in a wireless local area network; deriving a conflict graph of pair wise patterns of different access points representing which patterns conflict on a particular client, the conflict graph representing which patterns of the slots cannot be scheduled simultaneously in a slot so as to avoid interference; and generating a schedule for each access points in the slots such that no two conflicting patterns for two different access points are scheduled in the same slot.

### BRIEF DESCRIPTION OF DRAWINGS

These and other advantages of the invention will be apparent to those of ordinary skill in the art by reference to the following detailed description and the accompanying drawings, where like elements are like numbered when appearing in more than one drawing figure.

FIG. 1 is a schematic diagram depicting prior work directed to focusing on the how to use directional antenna to create efficient multihop networks of nodes;

FIG. 2 is a schematic diagram depicting prior work directed to figuring out the right beam pattern to use for a given client based on physical layer information; and

FIG. 3 is a schematic diagram of the inventive feature of using a directional antenna for multiple APs for increasing spatial reuse and removing interference in accordance with the invention.

### DETAILED DESCRIPTION

The application is directed to providing a solution for multiple access points APs with directional antenna with an objective to increasing network capacity and coverage for the wireless LAN. The invention provides an increase in the capacity of the network, provides better coverage to 802.11 clients due to lower interference among nodes and higher delivery ratio

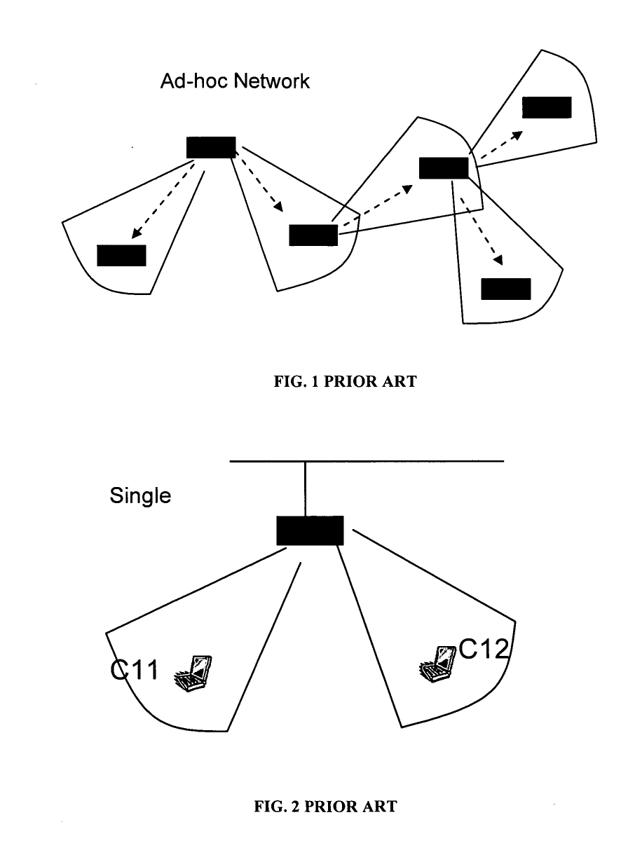

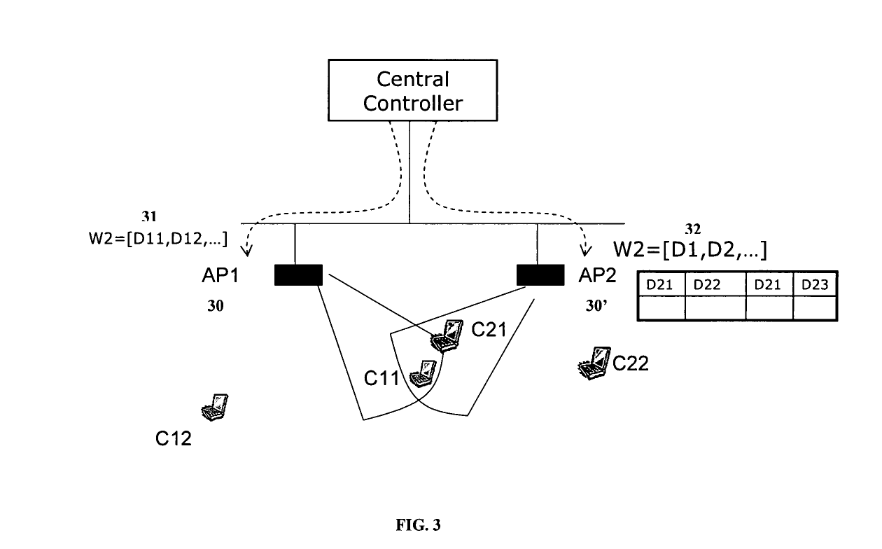

Referring to the block diagram, FIG. 1, access points APs 30, 30′ are synchronized to a common clock and follow a slotted timeline in a synchronized fashion. With each slot is defined a beam pattern to which the access point AP tunes into for the entire slot duration. A window of W 31, 32 of slots defined as [D_1,D_2, . . . , D_k] specifies the beam pattern D_i used in the ith slot of the window. Each AP J 30,30′ repeats through W_j. The system constructs W_j for each AP_j to meet two requirements: a) all client traffic for AP_j is served and b) two beam patterns do not conflict at the clients (resolving hidden terminal problems).

The window W is computed at the centralized controller and communicated to a corresponding access point AP. Note that commonly deployed WLANs that follow the thin AP architecture have the provision of a centralized controller managing the APs. Computation of W_j takes into consideration the conflict graph among the directional links and traffic requirements. W_j is recomputed if there is a change in client association or change in traffic.

In order to ensure that the access points APs are not deaf to the uplink client traffic, see C11, C12, C21, C22, the access points APs make use of a gratuitous Clear-To-Send to prevent clients from transmitting to access points APs when they are directed elsewhere. The framework enables the clients to transmit to the APs frequently enough (small slot size) to ensure that clients do not disassociate from the APs. The framework also ensures that APs send beacons periodically in omni-directional mode to ensure that clients do not disassociate.

All APs are synchronized to a common clock. This step can be realized in a variety of ways including using GPS at each AP, or NTP server at a central controller and NTP client at each AP, etc. The exact choice of synchronization is orthogonal to this invention, but we assume that the APs are closely synchronized such that the slotted timeline is executed correctly at each AP.

Time is divided into periods of execution. Divide a period of time (e.g. the next one second) into equal sized slots (e.g. 10 milliseconds). Each client is associated with one of the APs using some association procedure. The association procedure can be based on proximity, load on the AP, etc. and is orthogonal to this invention.

For each AP_j, for each associated client k that has traffic to exchange with the AP (in either directions of the link) determine a pattern D_i that causes minimum interference to clients of other APs. In one realization of a steerable directional antenna that uses phase arrays, the pattern can be adapted to minimize interference by modifying the weights (signal amplitude and phase) applied to the antenna elements of the phase-array antenna. The interference caused by a pattern on clients of other APs can be recorded in a training phase, where a sequence of packets is sent and the packet delivery ratio is measured at the clients. The higher the packet delivery ratio, the higher is the interference.

Then we compute the conflict graph of pair-wise patterns of different APs that represents which patterns conflict on a particular client. This graph represents which patterns cannot be scheduled simultaneously in a slot so as to avoid interference. CONFLICT GRAPH DETERMINATION: The conflict graph has each node representing an AP and pattern pair: <AP_j, D_i>, and links representing the conflict between two <AP, pattern>pairs.
For each pattern D_x for each AP_XXX, compute the list of all clients L that do not belong to this AP but receive traffic from AP_XXX when it uses pattern D_x.
For each client in L, get pattern D_y that is used by its associated AP_YYY to communicate with the client.
If node <AP_XXX, Pattern D_x> or <AP_YYY, Pattern D_y> does not exist in the conflict graph, add the node(s). Place an edge between <AP_XXX, Pattern D_x> and <AP_YYY, Pattern D_y>.

Then we generate a schedule W for each AP in slots such that no two conflicting patterns for two different APs are scheduled in the same slot. The scheduling algorithm can incorporate the throughput requirements, fairness requirements, and the current traffic for clients to determine the slot allocation. Any scheduling algorithm achieving the above objective can be used in this system.

Then we execute the schedule for the period.
At the beginning of each slot, indicate to the clients that will not be reachable by the pattern in this slot through omni-directional transmission to not send uplink traffic.
Switch to the pattern of this slot and transmit/receive from/to the AP/clients. Send a Clear-To-Send message to the clients that are reachable with this pattern.

When the current period expires, if there is change in traffic from/to client or if there is new client association or disassociation, then the process repeats from determining a pattern D_i that causes minimum interference to clients of other APs. Otherwise, the schedule is executed for the period.

The present invention has been shown and described in what is considered to be the most practical and preferred embodiment. It is anticipated, however, that departures may be made therefrom and that obvious modifications will be implemented by those skilled in the art. It will be appreciated that those skilled in the art will be able to devise numerous arrangements and variations which, not explicitly shown or described herein, embody the principles of the invention and are within their spirit and scope.

What is claimed is:

1. A method comprising the step of:
determining for each access point and each associated client that has traffic to exchange with the access point in either directions of a link a pattern of slots of times that causes minimum interference to clients of other access points in a wireless local area network;
deriving a conflict graph of pair wise patterns of different access points representing which patterns conflict on a particular client, the conflict graph representing which patterns of the slots cannot be scheduled simultaneously in a slot so as to avoid interference; and
generating a schedule for each access points in the slots such that no two conflicting patterns for two different access points are scheduled in the same slot.

2. The method of claim 1, wherein the step of determining comprises for a steerable directional antenna that uses phase arrays, adapting the pattern of slots to reduce interference by modifying signal amplitude and phase applied to the antenna elements of the phase array antenna.

3. The method of claim 1, wherein the step of determining comprises interference caused by a pattern on clients of other access points being recorded in a training phase where a sequence of packets is sent and a packet delivery ration is measured at the clients.

4. The method of claim 1, wherein the conflict graph comprises each node representing an access point and pattern of slots pair and links representing the conflict between two access point and pattern of slots pairs.

5. The method of claim 4, wherein the deriving step comprises determining for each pattern of slots D_x and its associated access point AP_XXX the list of all clients that do not belong to this access point but receive traffic from the access point AP_XXX when it uses pattern D_x.

6. The method of claim 5, wherein the deriving step comprises for each client in the list of clients, getting a pattern of slots D_y that is used by its associated access point AP_YYY to communicate with the client.

7. The method of claim 1, wherein the deriving step comprises if a node for access point AP_XXX and associated pattern D_x or access point AP_YYY and associated pattern D_y does not exist in the conflict graph, then an edge is placed between the pairs AP_XXX and associated pattern D_x and the pair AP_YYY and associated pattern D_y.

8. The method of claim 1, wherein the generating step comprises incorporating at least one of throughput requirements, fairness requirements, and current traffic for clients to determine the slot allocation.

9. The method of claim 1, further comprising the step of executing the schedule for a period.

10. The method of claim 9, wherein the coupler comprises an electrical power coupler.

11. The method of claim 9, wherein the modulator comprises a modulator with dual ports with the OFDM optical signal at one port and the digital signal at the other port.

12. The method of claim 1, wherein upon expiration of a period of execution of the schedule expiring, further comprising the step of repeating the steps of determining, deriving and generating in response to one a change in traffic from the client, a change in traffic to the client, a new client association and a new client disassociation.
